(19) United States
(12) Patent Application Publication
(10) Pub. No.: US 2018/0313108 A1
(43) Pub. Date: Nov. 1, 2018

(54) ANTI-FURLING FLAG POLE WITH ILLUMINATION

(71) Applicant: Mark L Ciaccia, Rochester, NY (US)

(72) Inventor: Mark L Ciaccia, Rochester, NY (US)

(21) Appl. No.: 15/964,666

(22) Filed: Apr. 27, 2018

Related U.S. Application Data
(60) Provisional application No. 62/491,000, filed on Apr. 27, 2017.

(51) Int. Cl. E04H 12/32; F21V 33/00; F21S 8/08; G09F 17/00

(52) U.S. Cl. CPC E04H 12/32; F21V 33/00; G09F 2017/0058; G09F 17/0091; G09F 2017/0008; F21S 8/088

(57) ABSTRACT

A flagpole with a pair of rotatable, spaced-apart connectors to which the flag is attached, and a light source mounted at the top end of the flagpole to downwardly illuminate a flag attached to the pole

This application claims priority under 35 U.S.C. § 119(e) from U.S. Provisional Patent Application No. 62/491,000 for an ANTI-FURLING FLAG POLE WITH ILLUMINATION, by Mark Ciaccia, filed Apr. 27, 2017, which is hereby incorporated by reference in its entirety.

This disclosed embodiment relates to a wall-mount flagpole, and more specifically to a flagpole with a pair of rotatable, spaced-apart connectors to which the flag is attached, along with a light source mounted at a top end of the flagpole to downwardly illuminate a flag pivotally attached to hang from the pole.

### BACKGROUND AND SUMMARY

On any windy day a flag has the propensity to become wrapped about the pole in essentially a “furled” state. Also it is known that the U.S. flag should be illuminated if flown at night. U.S. Pat. No. 8,069,811 to Ciaccia, also hereby incorporated by reference in its entirety, is directed to a flagpole with moveable flag clips and an electric lamp to illuminate the flag. However, in use the moveable clips had the potential to foul the end of the flag and did not always rotate freely. Moreover, there was no reliable and easily manufactured connector that was suitable for commercial use. Accordingly, the anti-furling flagpole disclosed herein provides at least a pair of rotatable flag connectors that are maintained in a spaced-apart relationship. The flagpole also includes a light source such as a solar-powered or AC-powered light in the form of a light emitting diode(s) (LED).

Disclosed in embodiments herein is a flagpole assembly comprising: a staff having a longitudinal axis, the staff having a lower end mountable to a wall with a mounting bracket, wherein at least one of said lower end and the mounting bracket, include a securing mechanism preventing the staff from rotating about the longitudinal axis relative to the mounting bracket; at least a pair of connectors rotatably retained on the staff at a fixed longitudinal distance from one another, each of the connectors including a slip ring rotatable about the longitudinal axis and each having an attachment mechanism operatively connected to a tab extending radially therefrom in order to releasably attach a flag or banner to the pair of connectors via the attachment mechanisms; a rod extending between and attached at its opposite ends to both connectors, the rod maintaining a rotational and spaced-apart relationship between the connectors about the staff and spaced from the flag attached to the pair of connectors at the attachment mechanisms, the rod ends terminating within a recess in each connector; and a light source mounted at an upper end of the staff, said light source being oriented in a downward directed manner for projecting light on the flag.

### BRIEF DESCRIPTION OF THE DRAWINGS

FIG. 1 is a perspective view of a flagpole including an illumination source in accordance with a disclosed embodiment;

FIG. 2 is an enlarged view of the illumination source and swivel connector on the upper portion of the flagpole embodiment of FIG. 1;

FIGS. 3A-3B show detailed views of a connector on a portion of the flagpole staff;

FIGS. 4A-4I are various assembly views of the rotating connector component;

FIGS. 5A-5B are perspective and side views of one masthead connector, and FIGS. 6A-6B are perspective and side views of an alternative masthead connector;

FIG. 7 is a schematic illustration of an illumination source including a solar power supply for use with an embodiment of the illuminated flagpole; and

FIGS. 8A-8G are illustrative representations of the design and surface features of an exemplary rotating connector component.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

The problem of a flag wrapping around a pole in the wind is particularly acute when the pole is attached, for example by a bracket, on the face of a building or structure 108. This is especially true when it is positioned at an angle relative to the structure, as compared to a free standing, substantially vertical flagpole. This flag wrapping problem is compounded when a flagpole installation is designed to remain in place for a significant period of time. For example, when the flagpole is provided with its own light source so that the flag remains illuminated at night.

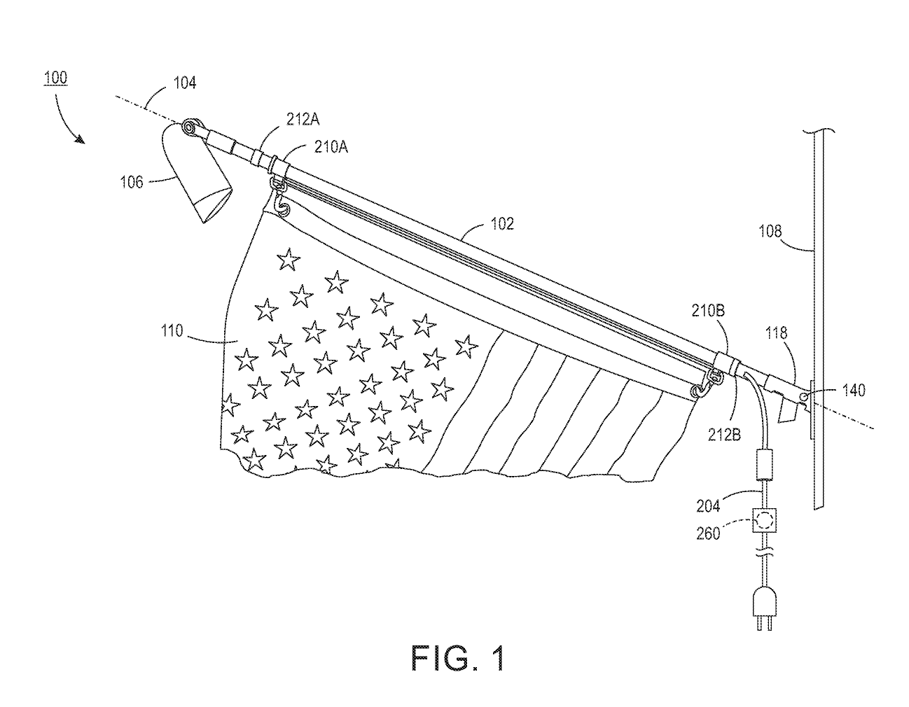

Referring to FIG. 1 which shows a general embodiment of the flagpole, indicated at 100, comprising a staff 102 with a longitudinal axis 104, flag 110 and a self-contained LED light or illumination source 106. In the AC power embodiment depicted a photocell 206 may be employed as a switching device to assure the illumination source operates only from dusk-to-dawn. Alternatively, light source 106 may include a battery and solar cell (not shown), located as one on the upper end of the staff.

Located on the lower end of staff 102 is bracket 118 affixed to a surface of a vertical wall or similar structure 108, whereby the bracket is indexed or pinned in such a manner to prevent shaft 102 from rotating. For example, the flagpole assembly depicted may include a securing mechanism such as a securing pin 140 passing through the staff 102 and the bracket 118, thereby preventing rotation of the staff relative to the mounting bracket. In one embodiment, staff 102 may be made from a metal tube, for example a 1.0-inch outside diameter tubing of generally circular cross-section and having a wall-thickness of about 0.06 inches or thicker. It should be appreciated that as an alternative to a circular cross-section, staff 102 may have a hexagonal, octagonal, or possibly even a slightly elliptical cross-section so as to improve the strength of the staff. The tube may be made of aluminum or other metals, and the metals may be treated (e.g., anodized), painted, etc. so as to provide a consistent color and finish. The bottom of staff 102 may include a through-hole of about 0.190 inch diameter to enable the locking pin 140 to pass therethrough for connection to bracket 118, and to prevent movement or rotation of the staff relative to the bracket. The staff may further include electrical wire(s) passing through the interior thereof to provide a source of power to the light source affixed to the upper end of the staff. In one embodiment the electrical wiring 204 may exit the end of the staff or may also exit the staff 102 though a grom meted hole in the tubing wall and passing to a power plug or hard-wired connection.

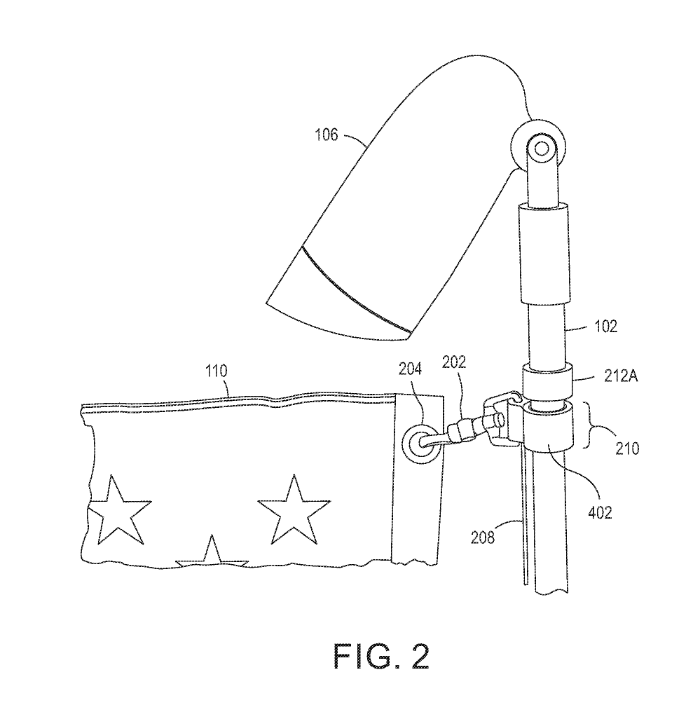

FIG. 2 further illustrates the flag-to-pole connection mechanism that provides for a rotationally mounted flag 110 on staff 102. Each of the connectors 210A and 210B includes a slip ring 402 having an inside diameter that is greater than the flag staff's outer diameter, making the slip ring free to slide and rotate along and about the longitudinal axis 104 of staff 102. Attachment mechanisms such as clips 202 are capable of being releasably attached to grommets 204 on the flag 110. The connectors 210 are fixed longitudinally about staff 102, and are thereby constrained along axis 104. The clips 202, and more particularly slip ring 402, allow the flag to rotate unconstrained, consequently flag 110 is incapable of becoming wound up or furled about staff 102.

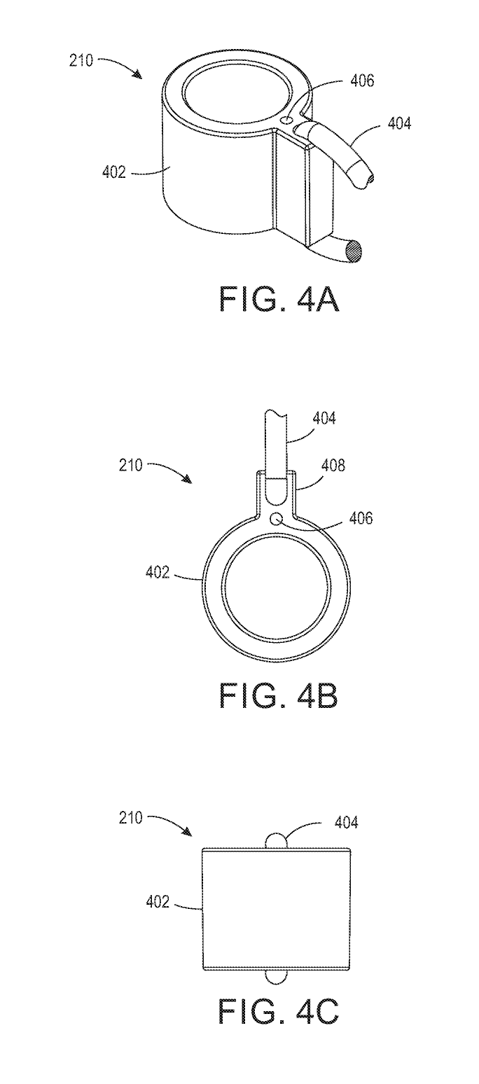

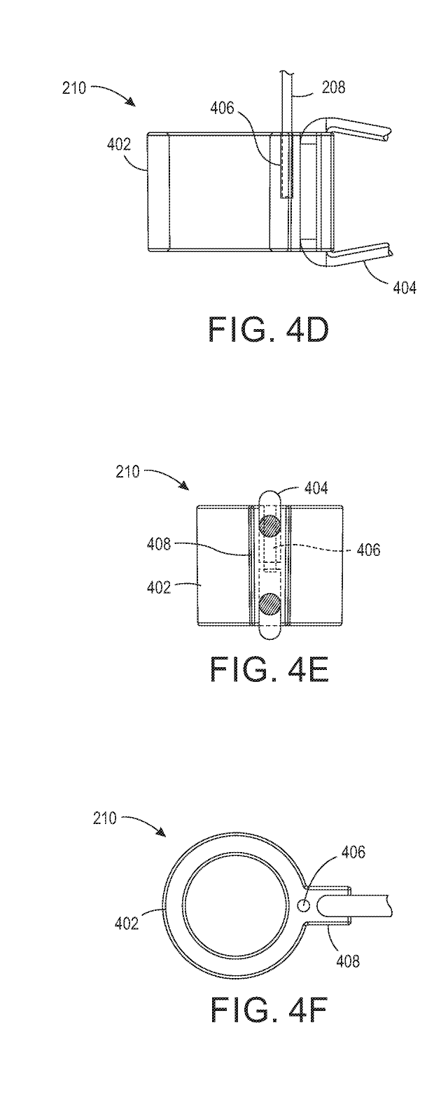

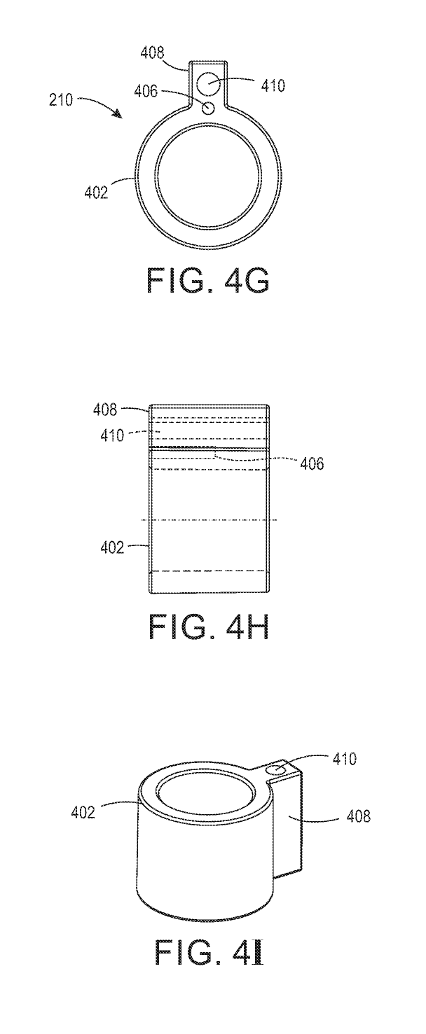

Connectors 210 further include a connecting wire or rod 208 that is attached at its opposite ends to or near each of the slip rings 402A and 402B to ensure that both connectors 210A and 210B do not slide or rotate independently, but rotate in concert and remain spaced apart about the axis 104 of flag staff 102. Rod 208 is made of a material (e.g., metal) that is firm yet elastic, so that the rod permits a level of flexure along its length as one connector is turned or twisted relative to the other, but the rod generally returns to its original linear shape, and thereby forces the connectors 210A and 210B, to which it is attached, back to an aligned configuration on staff 102. Rod 208 may also have a cross-section that is other than circular (e.g., square, hexagonal, etc.) so that the structural features of the rod are suitable for the application. For example, a hexagonal shape may increase the stiffness of the rod (decrease flexibility) without increasing the diameter or altering the material used. The length of the rod is sized to fit the particular embodiment, and for a flagstaff flying a common-sized flag (e.g., 3 ft.×5 ft.), the length of the rod is about 33 inches, putting clips 202 attached to the connectors at about 32 inches on center. The rod diameter may be subject to the cross-sectional shape and type of materials used, but would typically be in a range of 0.065 inches to about 0.25 inches, perhaps about 0.125 inches (e.g., 8 AWG). The rod may be made of various materials, including minimally-corroding metals such as aluminum, stainless steel, alloys and the like and it may be treated, tempered or otherwise processed to provide “spring-like” qualities whereby it returns to its original shape after being flexed or twisted. Objectives of the rod are to operatively link and maintain both connectors 210 in alignment with one another to ensure that they generally rotate in unison about the staff, in order to prevent a wind-blown flag from wrapping itself up about the flag staff 102. In one embodiment, connectors 210 include a hole or recess 406 to receive an end of the rod 208 as further described relative to FIGS. 4A-4I below.

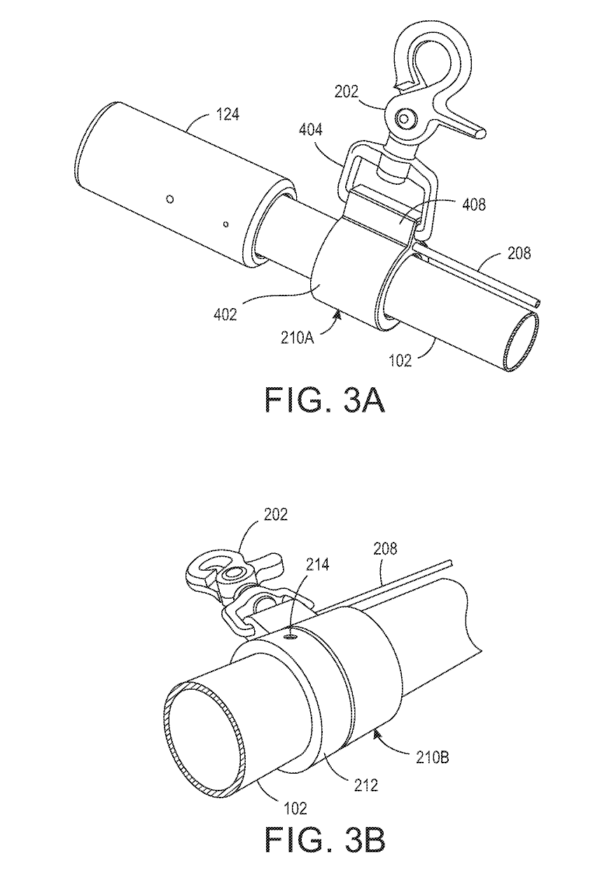

Travel limiting shaft collars 212A (optional) and 212B, are shown as secured to flag staff 102, via a setscrew(s), at a position that will establish the hanging position of flag 110 along axis 114. The shaft collar is a ring having an inside diameter slightly larger than the outside diameter of staff 102. Collars 212A and 212B can be fabricated from either plastic or a metal material, preferably a non-corrosive material. The collar further includes at least one threaded hole(s) for receiving a retaining feature such as a setscrew(s) that clamps the collar to the staff. As an alternative to a setscrew, the collar may be welded or glued to the staff, or a pin or other mechanical fastener may be used. In all cases, the outer surface of the collar should remain smooth to avoid the collar snagging or abrading the flag or banner material. As illustrated in the figures, the flag can be set so as to be located several inches (approx. 3″-12″) below illumination source 106. Ideally shaft collar 212A is not required, and its function of limiting the upward travel of connector 210A is accomplished by masthead collar 124 as shown in FIG. 3A. Optionally, as depicted in FIG. 2, upper shaft collar 212A may be located just above connector 210A and lower shaft collar 212B is placed just below connector 210B to limit the lateral displacement of the flag along axis 114, while permitting the connectors to freely pivot and slightly slide relative to the staff 102.

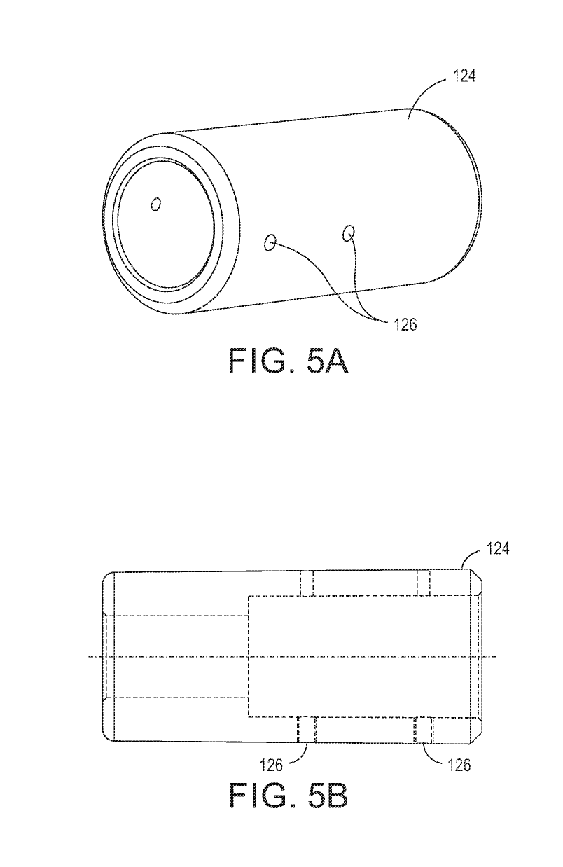

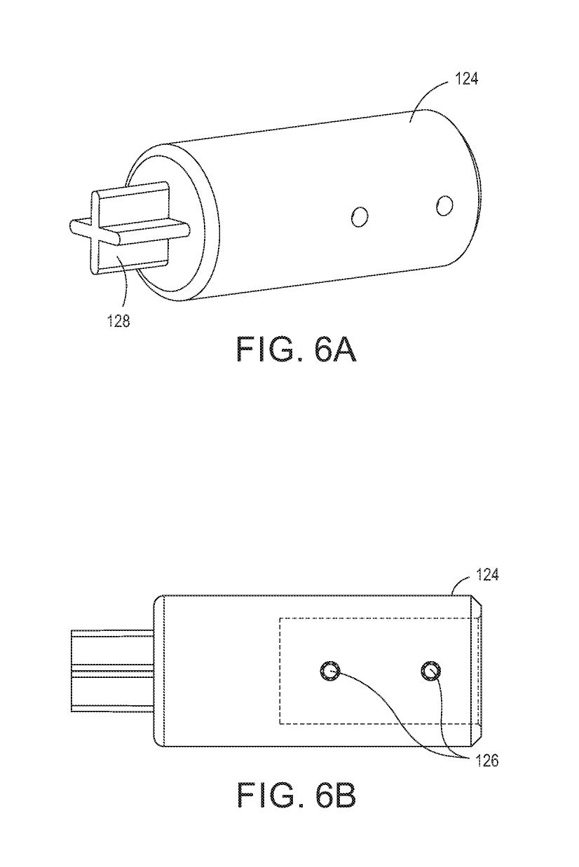

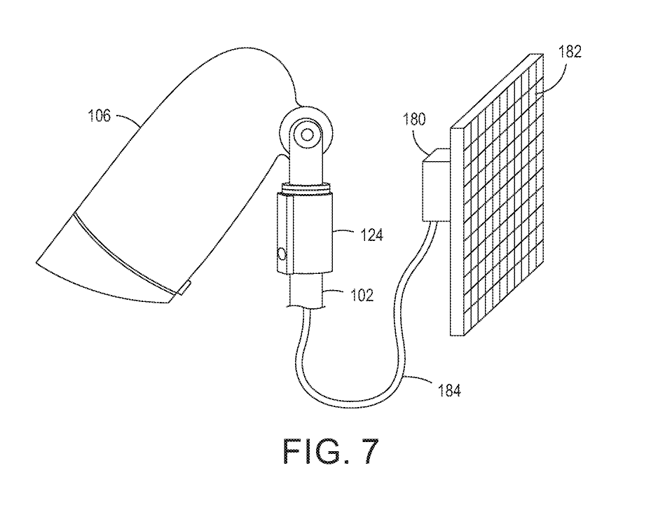

FIG. 1 shows illumination source 106 operatively attached to the top end of the flag staff and inserted into or connected to a masthead collar 124 on the staff 102 using a “friction fit” screw fit, etc. to retain the illumination source in a position that directs light generally downward onto flag 110. Referring briefly to FIGS. 5A-5B, and FIGS. 6A-6B, depicted therein are alternative embodiments of the masthead collar. In the configuration of FIGS. 5A-5B, collar 124 is a generally cylindrical collar having at least one inner diameter suitable for receiving the top end of staff 102 therein, and another inner diameter suitable for receiving a nipple from a light source fixture, which may be threadably engaged in the collar. The collar 124 is fastened to the staff 102 via set screws or pins placed in one or more holes 126. In the alternative masthead collar embodiment of FIGS. 6A-6B, collar 124 is also a generally cylindrical collar having an inner diameter hole suitable for receiving the top end of staff 102 therein. However, the collar is made to receive, on its upper end, a solar-powered light with photovoltaic panel assembly (not shown), where the assembly is fixed upon or adjacent the extending insert 128 by interference fit. Accordingly, insert 128 may be made of a size suitable for frictional contact within the interior of a tube or similarly-shaped receiver. And, as described previously, collar 124 is fastened to the staff 102 via set screws or pins placed in one or more holes 126. Also contemplated are one or more through holes for allowing wiring to pass between the illumination source and a solar panel and/or battery (e.g., FIG. 7).

As previously suggested, illumination source 106 may be a conventional LED assembly having an attached power source. Typically an LED requires only milliamps to operate, therefore in the embodiment depicted in FIG. 7 a rechargeable battery 180, connected to a solar photovoltaic panel 182, connected to the illumination source 106 via vires 184, is sufficient to power the LED illumination source. Additionally a photocell 206 (e.g., AC power embodiment of FIG. 1) may be employed as a switching device to assure the illumination source operates only from dusk-to-dawn. As may be appreciated, the illumination source 106 faces downward in order to direct or cast the illumination toward the flag, which will typically remain hanging below the pole due to the anti-furl attachment assembly described above. Keeping the illumination source downward-facing can be accomplished by locking or affixing the illumination source to the top of the pole at the masthead collar 124, and making sure the securing mechanism(s) maintains such alignment.

Having described the components of the anti-furling flagpole with an illumination source, attention is redirected to FIGS. 4A-4I, which show the details and various views of connector 210. As noted, connector 210 is operatively placed about the staff 102 for free rotation about the longitudinal axis 104 of staff 102. In one embodiment connectors 210A and 210B are identical, albeit reversed in orientation. As previously noted, connectors 210A and 210B are laterally positioned on staff 102 between stop collars 212A and 212B, which respectively define the upper and lower limits of sliding travel for the connectors and the connecting rod 208 spanning therebetween. Each of the connectors 210 are constructed with a circular or cylindrical slip ring 402 and a stub or tab 408 extending radially outward from the outer surface of the slip ring. The inner diameter of the slip ring is sized relative to the flagpole staff 102, so that slip ring 402 slides circumferentially over the outer-diameter of staff 102. In one embodiment, such as depicted in FIGS. 1-3B, the connectors 210 are further coupled to, yet separated from, one to another via connecting rod 208 as described above, to maintain spacing and relative position between the connectors. A clip 202 is positioned on or connected to a stub or tab 408, and in one embodiment, the clip may be operatively or pivotally connected via a D-ring 404 or similar mechanism. The D-ring 404 may be placed within a hole(s) or through hole 410 in tab 408. Connector 210 also provides for the attachment of connecting rod 208, which is affixed thereto. In one embodiment, the rod ends are secured within aperture 406, located in tab 408 on each of the connectors.

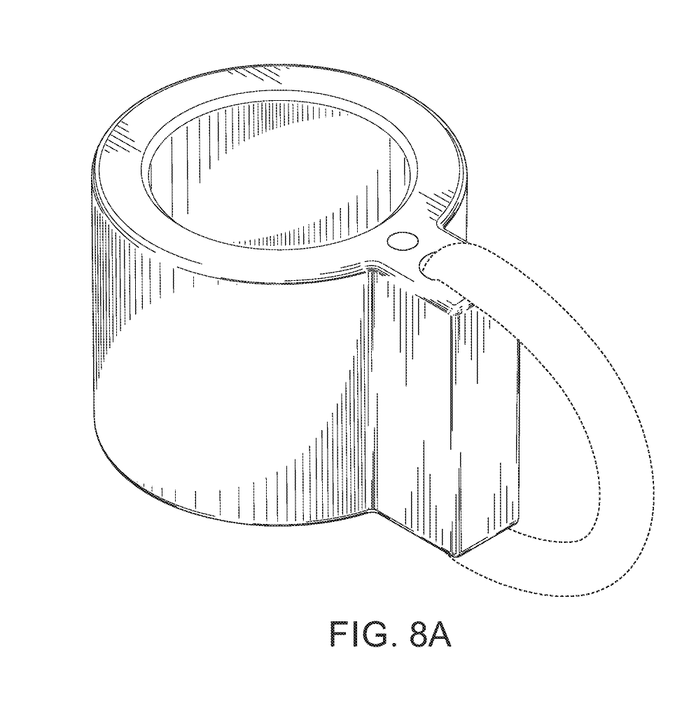

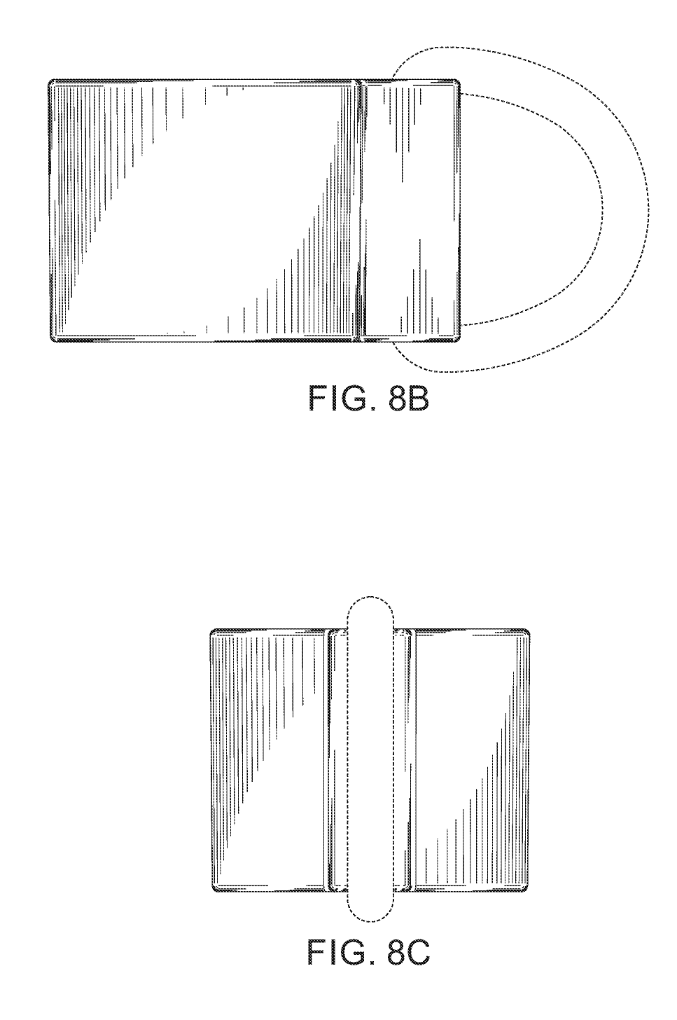

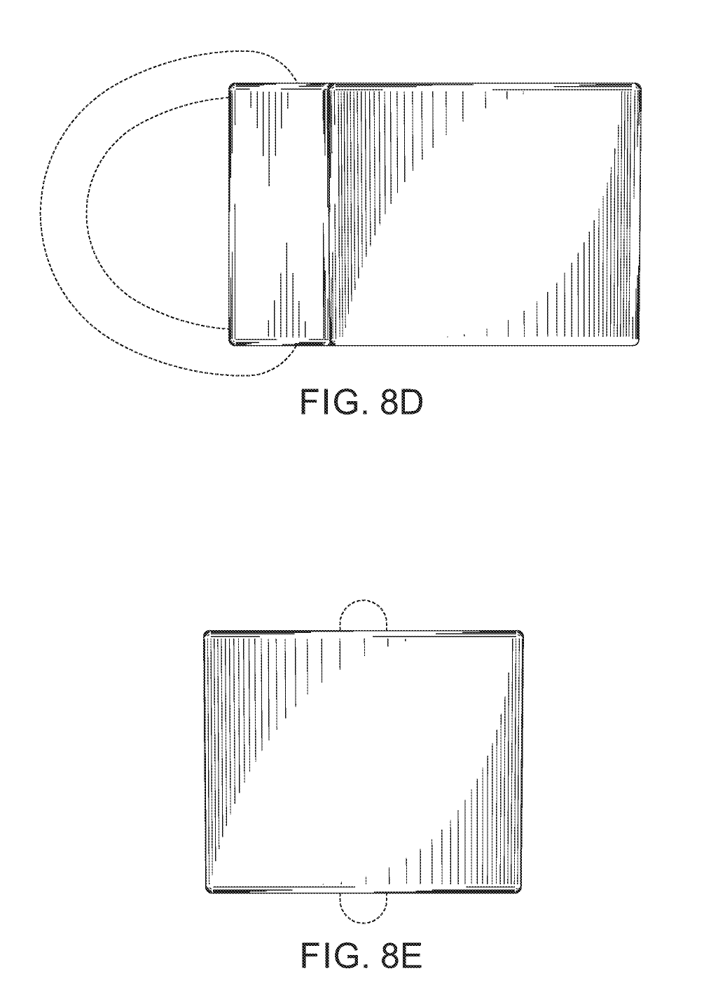

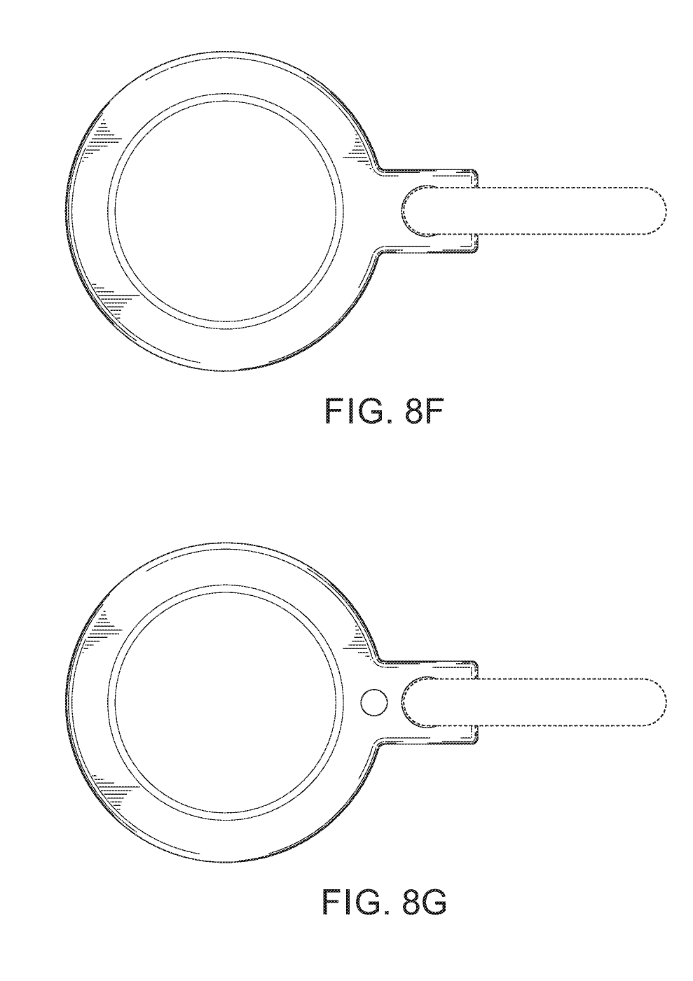

Referring briefly to FIGS. 8A-8G, depicted therein are representations of the new, original and ornamental design and surface features of a rotating connector. More specifically, FIG. 8A is a perspective view of the new design for a connector, with a D-ring shown in broken lines operatively attached to the connector. FIG. 8B is a left side view of the connector of FIG. 8A, again with an optional D-ring shown in broken lines attached to the connector. FIG. 8C is a top view of the connector of FIG. 8A, with the optional D-ring shown in broken lines attached to the connector. FIG. 8D is a right side view of the connector of FIG. 8A, with the optional D-ring shown in broken line format attached to the connector. FIG. 8E is a bottom view of the connector of FIG. 8A, once again with the optional D-ring shown in broken line format attached to the connector. FIG. 8F is a front view of the connector of FIG. 8A. FIG. 8G is a rear view of the connector of FIG. 8A. In summary, the ornamental design for a rotatable connector, suitable for use on a flagpole or similar pole, is shown and described.

In summary, connector 210, includes slip ring 402, and a radially-extending tab 408, which further facilitates the attachment of a D-ring 404 and clip 202 in an assembly. Notably the assembly provides means to secure clip 202 to connector 210. Moreover, clip 202 may be of any of various designs capable of being releasably attached to flag 110 via a grommet 204 or other reinforced hole therein. The connectors 210 allow the flag to swing freely around (360°) the longitudinal axis of the staff 102 thereby preventing the flag from get wound up or furled on the staff.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A flagpole assembly comprising:
a staff having a longitudinal axis, the staff having a lower end mountable to a wall with a mounting bracket, wherein at least one of said lower end and the mounting bracket include a securing mechanism to prevent the staff from moving relative to the mounting bracket;
at least one pair of connectors rotatably retained on the staff at a fixed longitudinal distance from one another, each of the connectors including,
a slip ring positioned about an outer periphery of said staff, said slip ring being rotatable about an axis parallel to the longitudinal axis,
a tab, extending radially from an outer surface of the slip ring,
a hole in said tab into which an attachment mechanism may be inserted, and
at least one recess in said tab;
a rod extending between and attached at its opposite ends to each of the at least one pair of connectors, the rod maintaining a rotational relationship between the connectors about the staff, each of the rod ends terminating within the recess in said tab of each of at least one pair of connectors; and
a light source mounted at an upper end of the staff, said light source being oriented in a downward directed manner for projecting light on a flag.

2. The flagpole assembly according to claim 1, wherein each of said connectors further includes a releasable attachment mechanism operatively connected thereto.

3. The flagpole assembly according to claim 1, wherein each of said connectors further includes a second recess, on an opposite side of said tab.

4. The flagpole assembly according to claim 1, wherein the securing mechanism includes a securing pin passing through the staff and preventing movement of the staff relative to the mounting bracket.

5. The flagpole assembly according to claim 1, wherein each of the connectors includes an attachment mechanism operatively affixed to the slip ring.

6. The flagpole assembly according to claim 5, wherein each of the connectors further includes, a tab extending radially from said slip ring, said tab including the recess in which the rod end is terminated.

7. The flagpole assembly according to claim 6, wherein said tab further includes at least one opening into which the attachment mechanism may be operatively connected, and where said attachment mechanism includes a releasable clip.

8. The flagpole assembly according to claim 1, wherein said slip ring has an inner diameter larger than an outer diameter of the staff.

9. The flagpole assembly according to claim 1, wherein the light source mounted at an upper end of the staff is attached to the staff by a masthead connector and where said masthead connector further limits the travel of at least one connector along the longitudinal axis.

10. A flagpole assembly comprising:
a staff having a longitudinal axis, the staff having a lower end mountable to a wall with a mounting bracket, wherein at least one of said lower end and the mounting bracket include a securing mechanism to prevent the staff from moving relative to the mounting bracket;
at least a pair of connectors rotatably retained on the staff at a longitudinal distance from one another, said distance fixed by a rod therebetween, each of the connectors including,
a slip ring positioned about an outer periphery of said staff, said slip ring being rotatable about an axis parallel to the longitudinal axis,
a tab, extending radially from an outer surface of the slip ring,
a hole in said tab through which an attachment mechanism may be inserted, and
at least one recess in said tab; and
said rod maintaining a rotational relationship between the connectors about the staff, and where opposite ends of the rod terminate within the recess in each of at least the pair of connectors.

11. Non-furling flag connectors for use in the connection of a flag to a flagpole staff, each connector including:
a generally circular slip ring sized for placement about an outer periphery of the flagpole staff, said slip ring being rotatable about the staff on an axis parallel to a longitudinal axis of the flagpole staff;
a tab, extending radially from an outer surface of the slip ring;
an attachment mechanism operatively coupled to said tab; and
at least one recess in said tab.

12. The connectors according to claim 10, wherein said attachment mechanism is operatively coupled to said tab via at least one hole in said tab.

13. The connectors according to claim 12, wherein said at least one hole in said tab is a through hole.

14. The connectors according to claim 10, further including a rod inserted within the at least one recess and spanning between two connectors to maintain a rotational and spaced-apart relationship between the connectors.
